(19) United States
(12) Patent Application Publication
(10) Pub. No.: US 2006/0144887 A1
(43) Pub. Date: Jul. 6, 2006

(54) Battery system

(76) Inventor: Hans-Peter Czernietzki, Krefeld (DE)

Correspondence Address: HARNESS, DICKEY & PIERCE, P.L.C., P.O. BOX 828, BLOOMFIELD HILLS, MI, 48303, US

(21) Appl. No.: 11/296,661

(22) Filed: Dec. 7, 2005

(30) Foreign Application Priority Data
Dec. 10, 2004 (EP) 04029303.7

(51) Int. Cl. H01M 2/10; D06P 1/52; B22C 1/22; B65D 85/00

(52) U.S. Cl. 224/902; 429/100; 523/139; 523/124; 206/703

(57) ABSTRACT

In order to provide a battery system which helps to reduce the maintenance works to be necessarily executed to a minimum while simultaneously avoiding shunting operations, the invention proposes a battery system, in particular for the carriages of a train, comprising a receiver unit for optionally receiving a battery, a charging device and/or the like, wherein the receiver unit is a mobile unit and is placed in a replaceable manner on a carriage of a train or the like.

### CROSS REFERENCE TO RELATED APPLICATIONS

This application claims priority to European patent application No. 04029303.7 filed Dec. 10, 2004 which is hereby incorporated by reference.

### BACKGROUND

The invention relates to a battery system, in particular for the carriages of a train. Battery systems of this type are known as such in the state of the art. They mostly consist of a housing, which serves for receiving a battery, in particular an accumulator as well as eventually a charging device for the accumulator. The housing including the battery placed therein is normally fixed beneath a carriage or a wagon of a train and serves in an emergency to supply current to the wagon or carriage of the train.

During the compilation of a train with different wagons or carriages, the shunting personnel check the intact condition of the used batteries. If this check shows that a battery is defective, not the battery but the entire carriage or wagon will be replaced for reasons of practicability. The replaced carriage or wagon will be then submitted to maintenance works, in which the defective battery will be replaced by a new battery. The replacement of a battery cannot be executed by the shunting personnel because the charging device of the battery system is adapted with respect to the power thereof to the battery associated with the charging device. Thus, a replacement of the battery requires knowledge of the features of performance of both the charging device and the battery. Furthermore, depending on the used charging device, partly different batteries have to be used. Depending on the carriage or wagon, different batteries can thus be used, which cannot be kept in stock by the shunting personnel for organizing reasons. Therefore, the wagons or carriages of a train are submitted to maintenance works for the purpose of exchanging a defective battery. Furthermore, the replacement of a defective battery has proved to require an extremely high effort for battery systems known in the state of the art. The replacement operation normally requires several minutes, such that less time is needed to displace the carriage or wagon of a train with the defective battery than to replace the defective battery by a new battery. Altogether, it might require a higher effort and thus be more costly to take out a wagon or carriage of a train and to submit it to maintenance works for replacement of a defective battery, but this is accepted, since the shunting personnel is under extreme time pressure during the compilation of a train. If namely the time, which has been previously calculated for the compilation of a train, is exceeded, undesired lateness of the train will inevitably occur, which, in the worst case, can affect the entire railway system.

The above described check and replacement system obviously requires an extremely high effort, since on the one hand extensive shunting operations and on the other hand maintenance works are required, which have to be executed separately. Since the wagon or carriage except the defective battery can be principally used, the above described check and replacement system is also extremely costly.

### SUMMARY OF THE INVENTION

It is the object of the invention to provide, on the base of the above described state of the art, a battery system which helps to reduce the maintenance works to be necessarily executed to a minimum while simultaneously avoiding shunting operations.

The above mentioned aim is achieved in that the invention proposes a battery system, in particular for the carriages of a train, comprising a receiver unit for optionally receiving a battery, a charging device and/or the like, wherein the receiver unit is a mobile unit and is placed in a replaceable manner on a carriage of a train or the like.

According to the invention, the battery system is a mobile unit. This mobile unit comprises a receiver unit for optionally receiving a battery, a charging device and/or the like. It can be placed in a replaceable manner on a carriage of a train or the like and can thus be easily replaced in case of need.

In contrast to the state of the art, not only the battery but the entire battery unit is thus replaced in case of a defective battery. A replacement of the entire battery unit can also be easily executed by the shunting personnel, since they so not have to check whether the used battery and the charging device, which is possibly coupled thereto, are matched to each other. On the contrary, the battery unit to be replaced is replaced by an already prepared battery unit that is ready for use. In order to facilitate the replacement operation, it is preferably provided that the battery unit can be placed on the carriage or wagon of the train by means of fasteners, which can be quickly handled. For this purpose, quick acting closures can be for example used. In this manner it is achieved that the replacement of a defective battery unit by a new battery unit can be very quickly realized, for example in less than two minutes.

During the compilation of a train, the shunting personnel keep a number of new battery units, which has to be determined according to experience, in stock. If during compilation of a new train it is detected that one or the other battery of a wagon or train is defective, the battery unit containing this defective battery is completely replaced by a new battery unit kept in stock. The defective battery unit can then be sent to maintenance works by the shunting personnel, where the battery unit or the battery will be checked and, if necessary, be repaired.

Thanks to the battery system proposed according to the invention it becomes for the first time possible to reduce the costs of the maintenance works that have to be necessarily carried out to a minimum. Furthermore, it helps to avoid extensive and unnecessary shunting operations. The shunting personnel namely neither have to shunt wagons or carriages of a train nor is a time consuming control with respect to the compatibility of battery and charging device required, since the entire battery system is replaced as a packet. If the shunting personnel thus detects that the battery of a wagon or a train is defective, they will replace the entire battery system by a new battery system. The new battery system comprises a battery as well as a charging device compatible therewith, such that in this connection no control has to be executed by the shunting personnel, but simultaneously it is assured that the newly used battery system can be used according to its purpose. In contrast to known battery systems, the battery system according to the invention stands out for being mobile and susceptible to be placed in an optionally replaceable manner on a carriage or wagon of a train.

According to another characteristic of the invention, the receiver unit of the battery system comprises receiver areas which are structurally separated from each other. In this connection, it can be provided that the receiver unit comprises a first receiver area for a battery, in particular an accumulator, and a second receiver area for a charging device. These receiver areas are equipped with a corresponding battery and a charging device compatible therewith by the maintenance workers. The thus prepared battery system is ready for use and is carried along by the shunting personnel during compilation of a train. If during compilation of a train the shunting personnel detects that one or the other battery system of a carriage or wagon to be used is defective, the entire battery system will be replaced by a new battery system carried along by the shunting personnel.

According to another characteristic of the invention, it is provided that the receiver unit comprises a third receiver area located between the first and the second receiver area. This receiver area can serve for receiving a connection device, the function of which will be explained in the following.

Preferably, the first and the second receiver area are respectively provided with an access opening that can be closed by means of a flap. This access opening allows access to the respective receiver area. Herein, the access openings are designed such that a battery or a charging device can be easily inserted through them into the respectively associated receiver area. The access openings can be closed by means of a correspondingly designed flap for the protection of the battery or charging device received by the receiver unit.

According to another characteristic of the invention, it is provided that the receiver unit is a supporting frame which forms a housing. This supporting frame comprises connection areas for placing a carriage or wagon of a train or the like, wherein quick acting closures serve for fixing the supporting frame to a carriage or wagon of a train. A quick replacement of the battery system is assured in this way.

According to another characteristic of the invention, the battery of the proposed battery system has a control unit. This control unit serves for detecting the features of performance of the battery and/or the operating states thereof and for providing the charging device with this information in order to carry out a charging operation adapted to the battery. Thus, the battery has its own intelligence in form of the control unit, which makes it possible to combine different charging devices with different batteries. Since the charging device knows from the control unit of the battery which type of battery is concerned, i.e. which features of performance the battery shows, a corresponding charging operation can be initiated, if necessary, by the charging device. Besides, the control unit is able to detect the operating state or the operating states of the battery and to transmit this information also to the charging device. Thus, the charging device is not only informed about the type of battery, but also about the operating state thereof, such that a recharging of the battery can be executed in a regular way.

In contrast to what is known from the state of the art, the charging device and the battery of the battery system are not fixedly matched to each other, but rather a free configuration is possible. In so far, the battery system has a modular structure, which means that batteries having different capacities can be optionally combined with charging devices having different powers. The control unit takes care that the charging device supplies a charging current depending on the determined features of performance and/or operating states. In so far, the battery thus has its own intelligence, which makes it possible to combine different types of battery with different types of charging device, since the charging current provided by the charging device is adjusted depending on the information collected and provided by the battery by means of the control unit.

The above described battery system makes it possible that a possibly defective battery can be easily replaced by a new battery by the service staff, since in contrast to the state of the art it is not necessary that the service staff is informed about type, nature and/or operating state of the new battery. The battery to be newly inserted rather automatically announces itself at the associated charging device and informs this one about its features of performance as well as its operating state. Thereupon, the charging device provides a correct charging current for the battery. Thus, the use of the battery system according to the invention does not require a special knowledge of the service staff with respect to the used charging device or with respect to the used battery. Extensive control and maintenance works can thus be advantageously avoided, since for a use according to the purpose of the battery system according to the invention it is sufficient that in case of a battery defect, this battery is replaced by a new one by the service staff, wherein it is not necessary to previously select the battery to be newly inserted in adaptation to the charging device. The replacement of only the battery is an alternative realization mode of the invention. In so far, the battery system according to the invention offers two possible replacement options, which are distinctive from each other. As explained above, the entire battery system, which is a mobile unit, can be optionally replaced in case of need. Alternatively, it is possible to only replace the battery of the battery system, wherein the battery to be replaced can be accessed via an access opening, which can be closed by means of a flap, of the receiver area for the battery. As the battery to be replaced has its own intelligence according to the above described realization alternative, a non-compatible use of charging device on the one hand and replaced battery on the other hand is safely excluded. The battery independently, i.e. automatically announces itself at the associated charging device of the battery system, whereupon the charging device automatically adjusts itself depending on the operating parameters of the newly inserted battery.

According to another characteristic of the invention, the battery system is characterized by a common connection device for the charging device, the battery and the control unit. Thus, the battery system has a connection device to which both the charging device and the battery including the control unit placed thereon can be optionally connected. It is thus not necessary to connect the charging device to the battery in a separate installation step. Both the charging device and the battery preferably have connector plugs, which will be connected to the connection device after insertion of the charging device and/or the battery into the battery system. The electric contact between charging device on the one hand and battery on the other hand is then established via the connection device.

According to another characteristic of the invention, the connection device comprises connections for a consumer. This design permits to replace the battery system as entirety in case of need. In case of a new installation of a battery system, the electric contact between consumer on the one hand and battery system on the other hand will be established via the connection device of the battery system. With established electric contact between battery system and consumer, the single components of the battery system, i.e. the charging device and/or the battery can be easily replaced all the same in the above described manner and be brought into electric contact with each other by means of the common connection device, whereby also an electric contact with the consumer will be then established.

The above described construction thus facilitates both the replacement of the battery system as such and the replacement of the components thereof, i.e. the charging device and/or the battery.

According to another characteristic of the invention, the battery system is characterized by a supporting frame, which receives the charging device, the battery with the control unit placed thereon and the connection device. This supporting frame preferably has standardized dimensions and can be for example placed beneath a train carriage or a train wagon by means of corresponding holders. The supporting frame can be for example of the type of a housing, this housing comprising separately formed receiver areas, i.e. chambers for the charging device, the battery with the control unit placed thereon and the connection device. Herein, the chambers can be formed, such that the service staff cannot confound the chambers, which means that the battery can only be placed in the chamber provided for it and the charging device can only be placed in the chamber provided for it.

The chambers, i.e. the receiver areas for the charging device or the battery are open on one side and can be closed by a flap. In so far, the flap can be called installation flap, which can be opened in case of need by the service and/or maintenance staff. If the flap is open, the battery or the charging device can be removed from the supporting frame of the battery system and be replaced by a new battery or a new charging device.

According to another characteristic of the invention, the connection device has a communication interface. This communication interface connects the control unit of the battery to the charging device. The communication interface serves for exchanging information between the charging device on the one hand and the control unit on the other hand.

According to another proposal of the invention, the control unit of the battery can be freely programmed. Thus, the service staff can freely determine charging cycles or the like.

Furthermore, the invention proposes a modular system comprising a plurality of different batteries and charging devices, which can be combined with each other according to the modular concept for forming a battery system according to the above explanations. It is an advantage of such a modular system that the available charging devices can be freely combined and optionally put together with the available batteries. The required maintenance or check works are thus reduced to a minimum.

### BRIEF DESCRIPTION OF THE DRAWINGS

Other advantages and characteristics of the invention will appear from the description made with reference to the following figures, wherein in the figures:

FIG. 1 is a schematic representation of the battery system according to the invention in a first view;

FIG. 2 is a perspective representation of the battery system according to the invention in a second view;

FIG. 3 is a flow chart showing the functioning of the battery system according to the invention;

FIG. 4 is a schematic representation of the compilation of a train with nine wagons;

FIG. 5 is a schematic representation of the shunting of the train shown in FIG. 4 and

FIG. 6 is a schematic representation of the train, the shunting of which has been accomplished.

### DESCRIPTION OF THE PREFERRED EMBODIMENTS

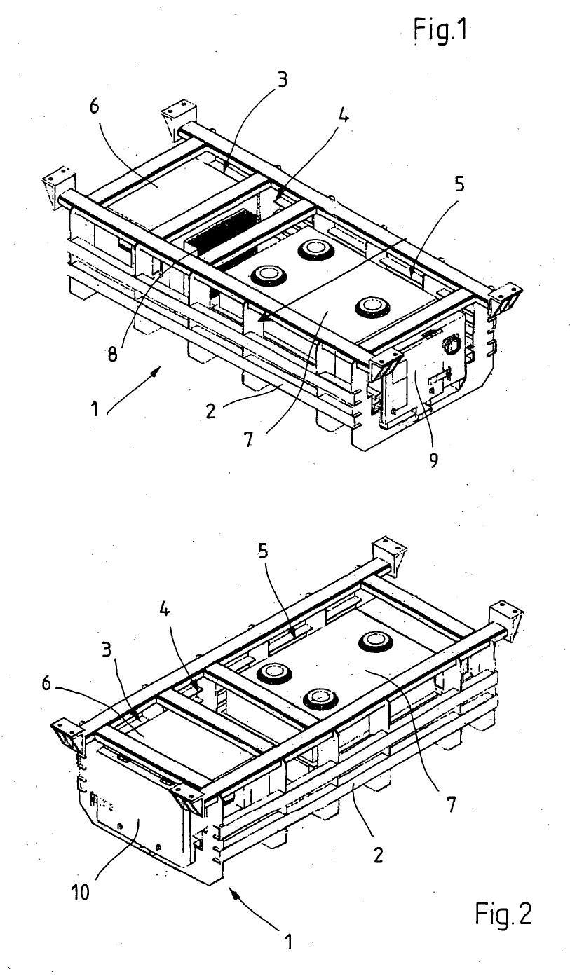

FIGS. 1 and 2 are respectively different views of battery system 1 according to the invention. Battery system 1 comprises a receiver unit 2 for optionally receiving a battery, a charging device and/or the like. Receiver unit 2 is preferably a supporting frame, which forms a housing, wherein the supporting frame can be for example formed by a skeletal frame made of U- or C-profiles.

Receiver unit 2 forms three chambers in total, i.e. receiver areas 3 through 5, wherein receiver area 3 serves for receiving a charging device box, which in turn supports the charging device, receiver area 4 serves for receiving a connection device 8 and receiver area 5 serves for receiving an accumulator box 7, which in turn contains an accumulator.

Receiver areas 3 and 5 are open on one side and can be respectively closed by means of a flap 9 or 10. Receiver areas 3 or 5 can be accessed from outside via these flaps 9 or 10, which can be called installation flaps.

Receiver unit 2 of battery system 1 according to the invention is a mobile unit and can be placed on a carriage of a train or the like in a replaceable manner, wherein preferably quick acting fasteners are used for the arrangement. In this manner, it is assured that receiver unit 2 of a battery system 1 can be exchanged, i.e. replaced, in a simple and over all quick way.

The charging device, which will still be described in the following, is preferably arranged within a charging device box 6. This charging device box 6 can be simply removed from receiver area 3 or be inserted into this one. After a correct insertion of charging device box 6 receiving the charging device into receiver area 3, the charging device will be electrically connected to connection device 8, which is present in receiver area 4, by means of corresponding contact plugs.

The battery, i.e. the accumulator, is as the charging device arranged within a box like receiver. This accumulator box 7 also receives, besides the accumulator, a control unit, which is no further represented in the figs. This control unit serves to determine the accumulator type, i.e. nature and size of the used accumulator, as well as to detect the operating state of the accumulator. After insertion of accumulator box 7, which receives the accumulator and the control unit, into receiver area 5, the accumulator is electrically connected to connection device 8, which is present in receiver area 7, by means of correspondingly formed connectors. Thus, the charging device and the accumulator are in electric contact via connection device 8. For the purpose of facilitating the insertion of accumulator box 7 into receiver area 5 provided for this, accumulator box 7 has heavy rollers on the lower side thereof, by means of which the box can be easily inserted into receiver area 5 or be removed from there. For a safe positioning of accumulator box 7 within receiver area 5 provided for this, a lock is preferably provided, which can be for example formed by laterally positioned, quick acting closures and which provokes a latching of accumulator box 7 with respect to receiver unit 2. The latching or unlatching can be for example carried out by means of clutches, which are placed beneath accumulator box 7, and which can be actuated by for example the forks of a common fork lift truck.

In comparison to the battery systems known from the state in the art, the battery system according to the invention has the advantage that it can be replaced in a simple manner. As the receiver unit is a mobile unit, this one can be replaced in a simple manner in case of need. Furthermore, it is possible to only replace either battery box 7, i.e. the accumulator, or charging device box 6, i.e. the charging device, wherein such a replacement, i.e. an exchange can be carried out in a very short time due to the design according to the invention. Thus, the battery system according to the invention permits a replacement of both accumulator box 7 and charging device box 6 within two minutes.

It is also an advantage of battery system 1 according to the invention that it is modular. In this context, modular means that batteries, i.e. accumulators having different capacities can be put together with charging devices having different powers, in receiver unit 2. Herein, receiver unit 2 is a standard supporting frame, which can receive charging device boxes 6 and accumulator boxes 7 of different type, form and size. Since according to the invention, the accumulator has its own intelligence in form of a control unit, battery system 1 according to the invention permits to optionally combine different accumulator types with different types of charging devices. The accumulator automatically announces itself at the charging device via the control unit thereof, whereupon the charging device independently adjusts the charging device parameters depending on the operating parameters of the accumulator. In case of a defect of an accumulator or a charging device, either the entire battery system or only the defect accumulator and/or the defect charging device can be thus replaced in a first step. Independently from the chosen way of action, the design according to the invention assures in any case that a quick replacement is possible while simultaneously maintaining the compatibility between accumulator and charging device.

In detail, the accumulator box receives an accumulator, a control unit, fuses as well as a load-break switch, which components are not explicitly represented in FIGS. 1 and 2. Herein, accumulator box 7 can be optionally equipped with an accumulator comprising a voltage of 24 to 110 volt and a capacity comprised between 80 and 360 Ah. The control unit placed within accumulator box 7 acquires the features of performance of the accumulator present in accumulator box 7 and transmits corresponding information to the charging device via connection device 8. Furthermore, the control unit can detect the momentary operating state of the accumulator, wherein the information relating thereto is also transmitted to charging device 6 via connection device 8.

If a new accumulator box 7, i.e. a new accumulator, is inserted into battery system 1, the accumulator present in accumulator box 7 announces itself on his own, i.e. automatically at the charging device by means of the control unit. The charging device is then provided with the necessary information with respect to the type of accumulator and the operating state and can start a charging operation adapted to the accumulator, if necessary.

Like accumulator box 7, charging device box 6 is also placed within receiver unit 2 in a replaceable manner. It can be optionally equipped with charging devices in a wide voltage range comprised between 24 volt and 110 volt and with a power range comprised between 1 kW and 30 kW.

Both accumulator box 7 and charging device box 6 can be replaced in a simple manner. Herein, the configuration of battery system 1 can be advantageously chosen in a free way, since different charging device boxes, i.e. different charging devices, can be combined with different accumulator boxes, i.e. different accumulators. The accumulator is specified by means of the accumulator control unit, the accumulator thus has a “memory” as well as an “intelligence”, which makes it possible to freely select the configuration of the accumulator on the one hand and the charging device on the other hand. In contrast to what is known from the state of the art, the charging device does not adopt an identification of the accumulator connected thereto, but the accumulator rather provides this identification itself.

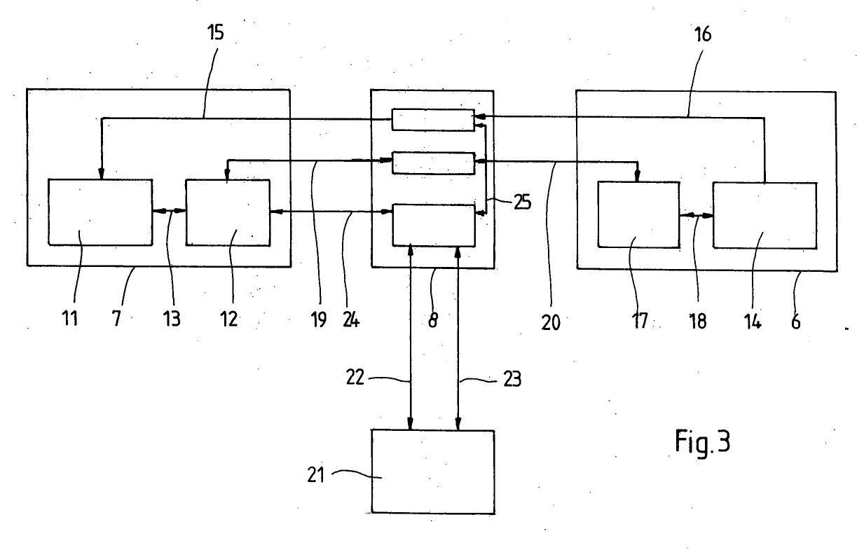

FIG. 3 is a schematic diagram which shows the functioning of battery system 1 according to the invention.

It is shown here that accumulator box 7 comprises an accumulator 11 as well as a control unit 12 as essential components. Herein, accumulator 11 and control unit 12 are in communicational connection, as indicated by arrow 13. Connection device 8 connects accumulator 11 to charging device 14 placed within charging device box 6, as indicated in FIG. 3 by arrows 15 and 16. Charging device 14 is in turn in communicational connection with a charging control unit 17, as indicated by arrow 18. Charging control unit 17 is in communicational connection with control unit 12 of accumulator 11 via connection unit 8. This communicational connection is represented by arrows 19 and 20.

A consumer 21 is also in connection with accumulator 7 or control unit 12 via connection device 8, as indicated by arrows 22 and 23, wherein arrow 22 represents the communicational connection and arrow 23 the electric connection. Arrows 24 and 25 identify the internal communication within connection device 8 respectively the communicational connection between consumer 21 on the one hand and control unit 12 on the other hand.

FIGS. 4 through 6 show the use of battery system 1 according to the invention by means of a practical example.

FIG. 4 is a schematic representation of a train 26, which is composed of nine wagons 27 in total. Each of these wagons has a frame 28 on the underside thereof, which frame serves for receiving a battery system 1 according to the invention.

In the exemplary embodiment represented in FIGS. 4 through 6, the capacity of the battery system is dimensioned such that the battery system can provide energy for maximum two wagons 27 in total. As the train shown in FIG. 4 is composed of nine wagons 27 in total, five battery systems 1 of the type according to the invention are provided in total.

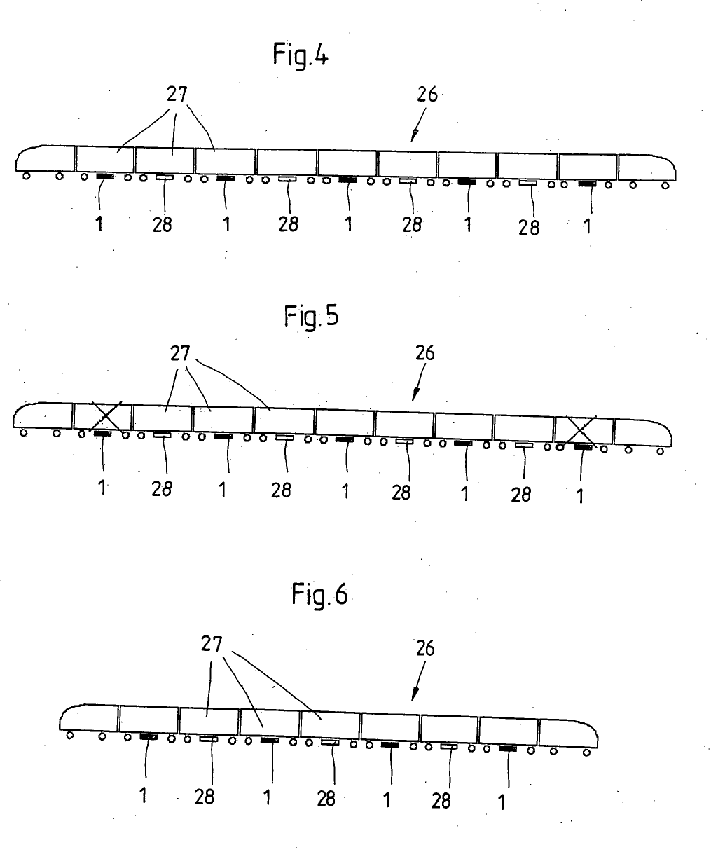

If two wagons 27 are now removed for reasons of composition or maintenance, as represented in FIG. 5, seven carriages 27 in total remain in the train, but only three battery systems 1 in total, the power of which would not be sufficient to provide the wagons 27 with the necessary energy. For this reason, a conversion of battery systems 1 is required, which caused a high working effort for the maintenance staff in the past. According to the new concept, i.e. the new battery system 1, the batteries, i.e. the accumulators or charging devices can be distributed in a simple manner over the remaining seven carriages 27.

As it is visible in FIG. 5, the first and the last carriage 27 are removed for minimizing the shunting works. Concerning the remaining seven carriages 27, the four battery systems 1, which have to be necessarily provided in total, are distributed, wherein the first carriage, the third carriage, the fifth carriage and the seventh carriage are respectively equipped with a battery system 1. The equipment of these carriages with a battery system 1 can be carried out quickly, simply and at low costs in the above described manner, such that it is not required, not necessary as in the past, to carry out shunting operations of the single carriages 27 in such a way that the result of the shunting operations is the train configuration shown in FIG. 6. The single carriages 27 of the train can be rather compiled while minimizing the shunting operations, wherein after these shunting operations, the battery systems are allocated. Since the allocation and the replacement of the battery systems can be carried out in a simple manner, the configuration possibility provided by the battery system according to the invention proves to be realizable in an especially simple manner and is thus less costly in comparison to the state of the art.

The exemplary embodiment described above by means of the figures shall only serve for explanation and is in so far not limiting. Within the scope of the invention it is in particular imaginable to use the battery system also for other purposes than for carriages or wagons of a train.

What is claimed is:

1. A battery system, in particular for the carriages of a train, comprising a receiver unit for optionally receiving a battery, in particular an accumulator, a charging device and/or the like, wherein the receiver unit is a mobile unit and is placed in a replaceable manner on a carriage of a train or the like.

2. A battery system according to claim 1, wherein the receiver unit comprises receiver areas which are structurally separated from each other.

3. A battery system according to claim 1 wherein the receiver unit comprises a first receiver area for a battery and a second receiver area for a charging device.

4. A battery system according to claim 1 wherein the receiver unit comprises a third receiver area, which is placed between the first and the second receiver area.

5. A battery system according to claim 1 wherein the first and the second receiver areas respectively have an access opening that can be closed by a flap.

6. A battery system according to claim 1 wherein the receiver unit is a supporting frame which forms a housing.

7. A battery system according to claim 1 wherein the supporting frame comprises connection areas for fixation on a carriage of a train or the like.

8. A battery system according to claim 1 wherein the accumulator comprises a control unit, by means of which features of performance of the accumulator and/or the operating states thereof can be detected.

9. A battery system according to claim 1 comprising a common connection device for the charging device, the accumulator and the control device.

10. A battery system according to claim 9 wherein the connection device comprises connections for a consumer.

11. A battery system according to claim 9 wherein the connection device comprises a communication interface.

12. A battery system according to claim 8 wherein the control unit can be freely programmed.

13. A modular system comprising a plurality of different accumulators and charging devices, which can be combined with each other; and a battery system having a receiver unit for alternatively receiving an accumulator or a charging device, wherein the receiver unit is a mobile unit and is placed in a replaceable manner on a carriage of a vehicle.
